(19) United States
(12) Patent Application Publication
(10) Pub. No.: US 2002/0189725 A1
(43) Pub. Date: Dec. 19, 2002

(54) Method for producing an aluminium strip for lithographic printing plates

(76) Inventor: Gunther Hollrigl, Schaffhausen (CH)

Correspondence Address: Fisher Christen & Sabol, Suite 1401, 1725 K Street NW, Washington, DC, 20006, US

(21) Appl. No.: 10/149,420

(22) PCT Filed: Dec. 13, 2000
(86) PCT No.: PCT/EP00/12649

(30) Foreign Application Priority Data
Dec. 23, 1999 (DE) 99811203.1

(51) Int. Cl. C22F 1/04

(52) U.S. Cl. 148/551

(57) ABSTRACT

A process for manufacturing a strip of aluminium or an aluminium alloy for electrolytically roughened lithographic printing plate is such that the metal is continuously cast to a maximum thickness (dₐ) of 4.5 mm, the cast strip is rolled without further heating to an intermediate thickness (d_{z}) amounting to 30 to 80% of the total reduction in thickness (dₐ-dₑ), the strip which has been rolled to intermediate thickness (d_{z}) is annealed in a temperature range of 250 to 320° C. in such a manner that at low strength recovery takes place without recrystallisation occurring, and the after the intermediate anneal, the strip is rolled to final thickness (dₑ) without further heating. Lithographic printing plates manufactured according to the process exhibit good strength properties after a stove-lacquer process.

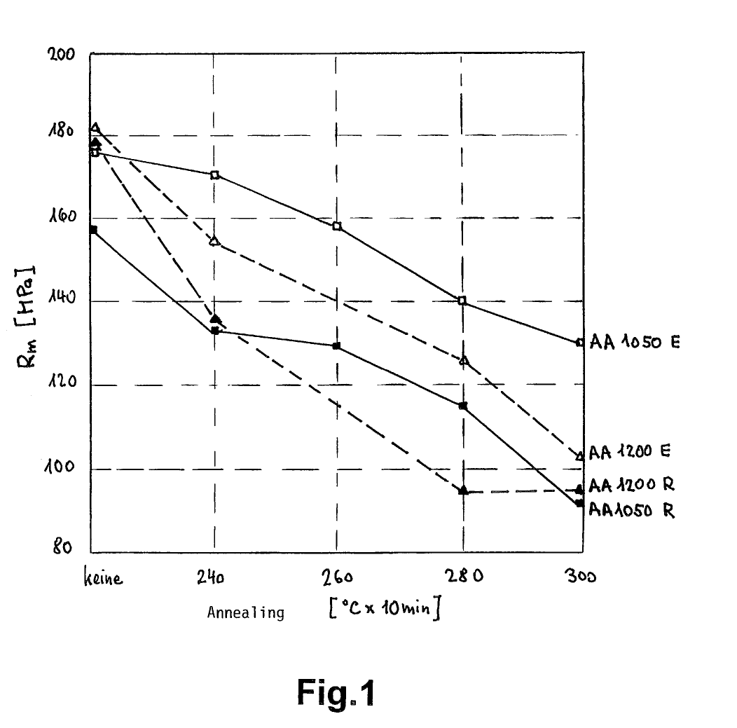

The invention relates to a process for manufacturing a strip of aluminium or an aluminium alloy for electrolytically roughened lithographic printing plates, whereby the metal is continuously cast to strip form and the cast strip is subsequently cold rolled to final thickness (dₑ). Also within the scope of the invention are litho-graphic printing plates with electrolytically roughened surface.

Lithographic plates of aluminium, which are typically about 0.3 mm thick, exhibit advantages over plates made of other materials—of which only some are mentioned here viz.:

A uniform surface which is well suited for mechanical, chemical and electro-chemical roughening.

A hard surface after anodising—which enables a large number of copies to be printed.

Light weight

Low manufacturing costs

The publication ALUMINIUM ALLOYS AS SUBSTRATES FOR LITHOGRAPHIC PLATES by F. Wener and R. J. Dean, 8^{th} International Light Metal Conference, Leoben-Vienna 1987, provides an overview of the manufacture of strips for litho-graphic printing plates.

Today lithographic plates are mainly manufactured using aluminium strips which are produced from continuously cast ingots by hot and cold rolling and intermediate annealing (heat-treatment). In recent years various attempts have been made to process strip cast aluminium materials to lithographic plates.

In EP-A-0 821 074 a process for manufacturing an aluminium strip for lithographic plates is described whereby the metal is continuously cast in the roll gap between cooled rolls of a strip casting machine and then rolled to final thickness without intermediate annealing. Often, the specifications for lithographic sheets state maximum values for strength which can be achieved without intermediate annealing only when the thickness of the cast strip is much less than 3 mm. In practice, however, with conventional strip casting machines such small thicknesses of cast strip are not easy to produce with good quality.

Known from EP-A-0 653 497 is a process for manufacturing an aluminium strip for lithographic printing plates in which first a cast strip of maximum thickness 3mm is likewise produced using a roll caster. The cast strip is subjected to an intermediate, recrystallising anneal during cold rolling. This anneal is carried out—at a temperature of at least 300° C. and a heating up of at least 1° C./sec—stationary in coil form in a furnace, preferably at temperatures of 400 to 550° C. in a continuous anneal furnace. After this anneal the cast strip is cold rolled directly to a final thickness of 0.5 mm.

On cold rolling aluminium strips it is also known, in particular with reductions exceeding 90%, to perform a recrystallisation intermediate anneal in a temperature range of normally 300-400° C.

The object of the present invention is to provide a process of the kind described at the start which, without costly equipment, results in a lithographic strip with good strength also after a stove-lacquering cycle on lithographic printing plate manufactured from the strip.

That objective is achieved by way of the invention in that:

a) the metal is cast to a maximum thickness of 4.5 mm,

b) without further heating, the cast strip is rolled to an intermediate thickness

which corresponds to 30 to 80% of the total reduction in thickness,

c) the strip rolled to intermediate thickness is annealed in a temperature range

of 250 to 320° C. in such a manner that at low strength recovery takes place

without recrystallisation occurring, and

d) after the intermediate anneal the strip is rolled to final thickness without

further heating.

Here the expression “Without further heating” means that, between the point of leaving the roll gap of the casting machine and rolling to intermediate thickness, the cast strip receives no further external heating. If the cast strip, which after leaving the roll gap of the casting machine still exhibits a relatively high temperature for a certain length of time, is rolled to intermediate thickness shortly after casting, then the starting temperature for rolling, especially for large strip thicknesses, can be increased. For low strip thicknesses the processing to intermediate thickness corresponds to cold rolling.

The essential aspect of the process according to the invention lies in the intermediate annealing which serves the purpose of achieving recovery in the structure and not the creation of new grains as is the case with the normal recrystallisation intermediate annealing according to the state-of-the-art procedures.

Aluminium strips subjected to the annealing treatment according to the invention undergo a smaller loss in strength after a stove lacquer cycle than strips that have been subjected to a recrystallising anneal.

The process according to the invention results, therefore, in lithographic printing plates which, also in connection with high stove lacquering temperatures of up to 300° C., offer advantages with respect to final strength over conventionally manufactured lithographic sheets.

The metal is preferably cast with a maximum thickness of 3.5 mm, in particular 2.0 to 3.0 mm, advantageously 2.4 to 2.8 mm. The cast strip obtains thus an ideal microstructure in a region close to the surface which, in combination with the recovery anneal according to the invention, results in strip rolled to final thickness with a surface structure exhibiting excellent etching behaviour.

Basically any strip casting method may be employed to produce the cast strip, whereby, ideally rapid solidification accompanied by warm forming in the roll gap is desired. Both of the properties just mentioned are achieved e.g. by the roll-casting process in which the metal is cast into strip form between cooled rolls. As a result of the further processing of the cast strip by cold rolling and non-recrystallising intermediate annealing the advantageous structure of the strip near the surface is retained due to rapid solidification.

The continuous casting method enables, at the same time, high solidification rates and very fine grain sizes in the regions close to the surface as a result of dynamic recovery immediately after the cast strip emerges from the roll gap of the casting machine.

The further processing of the cast strip takes place by winding the cast strip into a coil of the desired size. In the next process step the strip is rolled to the desired intermediate thickness in a cold rolling mill suitable for lithographic sheet, and after the recovery anneal rolled to final thickness in the normal range of about 150 to 300 μm.

The intermediate thickness at which the recovery anneal is carried out, the temperature and the duration of annealing is selected on the one hand with respect to the initial thickness of the cast strip and on the other hand with respect to the composition of the material being processed. By means of a simple series of trials, however, the expert in the field is able to determine without difficulty the parameters necessary to achieve the desired recovered condition.

The cast strip is preferably rolled to an intermediate thickness corresponding to at least 50% of the total reduction in thickness, whereby the suitable intermediate thickness is approximately 1.0 to 1.6 mm.

The recovery anneal of the material rolled to intermediate thickness preferably lies in a temperature range of 260° C. to 300° C., usefully in a temperature range of about 270 to 290° C., whereby the strip rolled to intermediate thickness is annealed for a duration of about 2 to 5 h.

Apart from the advantage of uniform etching behaviour, a strip processed according to the invention exhibits excellent mechanical properties e.g. a high strength which falls only slightly during the stoving of a photosensitive lacquer during the production of lithographic plates.

The strip manufactured according to the invention is equally suitable for etching in HCI and HNO₃ electrolytes, whereby the advantages of the microstructure achieved stand out especially when etching in an HNO₃ electrolyte.

All aluminium alloys used for the production of lithographic printing plates may be employed for manufacturing the lithographic strip according to the invention.

Particularly preferred are alloys from the following series viz., AA 1xxx, AA 3xxx or AA 8xxx for example the alloys AA 1050, AA 1200 or AA 3103.

The above mentioned advantageous microstructure in the region close to the surface of the strip is essentially the result of rapid solidification at the surface. As a result of the high solidification rates, the secondary phase particles precipitate out in the microstructure in a very fine form and high density . These particles act as first sites to be attacked on etching, in particular if the electrolytic roughening is carried out in an HNO₃ electrolyte. When the solidification rate at the surface is fast, the above mentioned particles exhibit an average spacing of less than 5μm and form an interconnected network of uniform points that are attacked on the surface. The actual three-dimensional roughness pattern begins to grow, starting from this first, very dense points of attack that are distributed uniformly over the whole surface of the strip. The small size of the above mentioned intermetallic phases has the further advantage that the time require for the electrolytic dissolution at the start of etching is considerably reduced, with the result that electrical energy can be saved. As a result of the rapid solidification in the surface region non-equilibrium phases are formed by preference; the dissolution rate of these fine particles is high.

A further important microstructural feature of the strip manufactured according to the invention is the small grain size which is produced in the surface region during strip casting. The high density of points at which the grain boundaries intersect the surface, together with a high density of defects in the grains them-selves, leads to chemically active points of attack for continuous formation of etching pits.

During electrochemical etching, the microstructure in the strip surface described above results in the uniform roughness pattern required of lithographic printing plates. The advantages resulting from the use of the strip manufactured according to the invention are as follows:

Uniform etching pattern as a result of a high density of potential points of

attack at the surface

Etching in an HNO₃ electrolyte under critical electrochemical process

conditions

Extension of the etching parameters into the range of low density of charge

and thus savings in energy

Prevention of etch defects in HNO₃ electrolytes as a result of undesirable

passivation reactions

Formation of a dense network of cracks in the oxide layer in the passivation

range of the anodic potential as a result of a high density of intermetallic

particles of non-equilibrium structures

Formation of a dense network of defects in the natural oxide layer in the

passivation range of the anodic potential as a result of a small grain size with

many points of intersection with the oxide layer.

An important property of the lithographic sheet rolled to the desired final thickness of 0.2 to 0.3 mm is obtained from the subsequent process step viz., the electro- chemical roughening, which should achieve an etch structure on the surface that is as uniform as possible. To that end electrolytes of dilute hydrochloric acid (HCI) and electrolytes of dilute nitric acid (HNO₃) are employed which, depending on the type of plate required, produce a characteristic etch pattern under the influence of an alternating current.

If the etching is performed in a nitric acid electrolyte, it is found in practice that a uniform etch pattern is obtained only if certain etching parameters are observed. If e.g. for reasons of costs too low a charge (Coulomb) is employed, the etch pattern is usually irregular—in the form of streaks where no etching has taken place. If etching is carried out under these critical conditions, all the fine differences in the grain structure of the substrate (lithographic strip) become evident and it is possible to classify the lithographic material used.

The reason for the sensitivity of the HNO3 electrolyte to the electrolytic etching behaviour of aluminium lies in its passive range (passive oxide) and the related difficulty in initiating etching pits. Only at an anodic potential of +1.65V (SCE) is this passive range overcome by the formation of etching pits, whereas the formation of pits in HCI begins already at a corrosion potential of −0.65V (SCE). For anodic etching in HNO3 electrolytes this has the result that the intermetallic phases are dissolved first in the potential range of −0.5 to −0.3 V (SCE), before the aluminium matrix is attacked and pitting occurs. The distribution of these intermetallic phases forms a first network of pits on the etched surface; for that reason the areal density of these phases on the surface is important.

As explained above, the strip manufactured according to the invention, with inclusion of a recovery anneal, exhibits the advantage over strip material which has undergone a recrystallisation anneal, in particular in the case of lithographic printing plates after a stove-lacquer cycle at temperatures in the range of approx. 270 to 300° C.

The advantage of the strip material manufactured according to the invention over a strip material with conventional recrystallising intermediate anneal is revealed in the following table which shows strength values of the alloys AA 1050 and AA 1200 at final thickness in the cold rolled condition and after various simulated stove-lacquer treatments.

The starting material for the investigations was a 4.5 mm thick strip produced on a roll caster machine. This strip was cold rolled to an intermediate thickness of 1.5 mm and after intermediate annealing, cold rolled further to a final thickness of 0.28 mm

The following intermediate anneal conditions were employed:

R (Recrystallising anneal) 380° C.×2 h

E (Recovery anneal ) 300° C.×2 h

The details of temperature and duration refer to the metal temperature and duration of annealing after the strip has been heated with a heating rate of 100° C. to the annealing temperature. The strength at failure (Rm) was taken as the strength characteristic.

The stoving of a photosensitive lacquer was simulated by immersing in a salt bath for the duration of 10 min.

TABLE 1

| | | | Strength at failure |
|---|---|---|---|
| Alloy | Intermediate anneal | Stove-lacquer cycle | Rm (MPa) |
| AA 1050 | R | — | 157 |
| | E | | 177 |
| | R | 240° C. × 10 min | 132.8 |
| | E | | 170 |
| | R | 260° C. × 10 min | 129.0 |
| | E | | 158.2 |
| | R | 280° C. × 10 min | 115.4 |
| | E | | 140.0 |
| | R | 300° C. × 10 min | 91.3 |
| | E | | 130.7 |
| AA 1200 | R | — | 179 |
| | E | | 181 |
| | R | 240° C. × 10 min | 136.2 |
| | E | | 155.1 |
| | R | 280° C. × 10 min | 93.2 |
| | E | | 125.3 |
| | R | 300° C. × 10 min | 93.6 |
| | E | | 103.4 |

1. Process for manufacturing a strip of aluminium or an aluminium alloy for electrolytically roughened lithographic printing plates, whereby the metal is continuously cast to strip form and the cast strip is subsequently cold rolled to final thickness (dₑ), characterised in that,
d) the metal is cast to a maximum final thickness (dₑ) of 4.5 mm,
e) without further heating, the cast strip is rolled to an intermediate thickness (d_{z}) which corresponds to 30 to 80% of the total reduction in thickness (dₐ-dₑ),
f) the strip rolled to intermediate thickness (d_{z}) is heated in a temperature range of 250 to 320° C. in such a manner that at low strength recovery takes place without recrystallisation occurring, and
d) after the intermediate anneal the strip is rolled to final thickness (dₑ) without further heating.

2. Process according to claim 1, characterised in that the metal is cast to a maximum thickness (dₐ) of 3.5 mm, in particular 2.0 to 3.0 mm, preferably 2.4 to 2.8 mm.

3. Process according to claim 1, characterised in that the cast strip is rolled to an intermediate thickness (d_{z}) corresponding to at least 50% of the total reduction in thickness (dₐ-dₑ).

4. Process according to one of the claims 1 to 3, characterised in that the intermediate thickness (d_{z}) amounts to 1.0 to 1.6 mm

5. Process according to one of the claims 1 to 4, characterised in that the strip rolled to intermediate thickness (d_{z}) is subjected to an intermediate anneal in a temperature range of 260 to 300° C., in particular 270 to 290° C.

6. Process according to one of the claims 1 to 5, characterised in that the strip rolled to intermediate thickness (d_{z}) is heat-treated for an interval of time (t) of 2 to 5 h.

7. Process according to one of the claims 1 to 6, characterised in that the metal is continuously cast to strip form in a roll-gap between cooled rolls of a strip-casting machine.

8. Process according to one of the claims 1 to 7, characterised in that an alloy of the AA 1xxx, AA3xxx or AA8xxx series is cast to strip form.

9. Lithographic printing plate with electrolytically roughened surface, characterised in that the said plate is manufactured from strip made using the process according to one of the claims 1 to 8.

10. Lithographic printing plate with electrolytically roughened surface, characterised in that the said plate is manufactured from strip made using the process according to one of the claims 1 to 9 and is provided with a stoved photo-sensitive coating.
